(19) United States
(12) Patent Application Publication
(10) Pub. No.: US 2013/0018631 A1
(43) Pub. Date: Jan. 17, 2013

(54) METHOD AND SYSTEM FOR MEASURING TIME

(71) Applicants: MING-HUNG CHOU, TAIPEI CITY (TW); CHING-FENG HSIEH, TAIPEI CITY (TW)

(72) Inventors: MING-HUNG CHOU, TAIPEI CITY (TW); CHING-FENG HSIEH, TAIPEI CITY (TW)

(73) Assignees: ASKEY COMPUTER CORP.; ASKEY TECHNOLOGY (JIANGSU) LTD.

(21) Appl. No.: 13/219,764

(22) Filed: Aug. 29, 2011

(30) Foreign Application Priority Data
Jul. 15, 2011 (TW) 100125204

(51) Int. Cl. G04F 10/00

(52) U.S. Cl. 702/178

(57) ABSTRACT

A method for measuring time includes setting a clock mask by a starting signal and an ending signal generated upon commencement of measurement and termination of measurement, respectively; obtaining a cycle number of a reference signal under the clock mask to calculate a preliminary time; correcting the preliminary time according to a plurality of phase shift signals generated based on the reference signal; and minimizing an error of the preliminary time by increasing the quantity of the phase shift signals. The method enhances the accuracy of the measured time, times up time measurement, and reduces the required circuit areas. A system for measuring time is further introduced for use with the method.

### CROSS-REFERENCE TO RELATED APPLICATION

This non-provisional application claims priority under 35 U.S.C. §119(a) on Patent Application No(s).100125204 filed in Taiwan, R.O.C. on Jul. 15, 2011, the entire contents of which are hereby incorporated by reference.

### FIELD OF TECHNOLOGY

The present invention relates to methods and systems for measuring time, and more particularly, to a method and system for measuring time quickly and precisely.

### BACKGROUND

Time measurement usually requires counting the number of cycles of a fundamental frequency signal between the commencement of measurement and the termination of measurement, and obtaining a time according to a preset frequency of the fundamental frequency signal. Hence, the precision of the calculated number of cycles of the fundamental frequency signal affects the accuracy of the calculated time.

Normally, calculation of the number of cycles of the fundamental frequency signal requires counting, that is, counting the number of cycles of the fundamental frequency signal during a gate time period that starts from a point in time of commencement of the fundamental frequency signal and ends at a point in time of termination of the fundamental frequency signal.

Nonetheless, the number of cycles of the fundamental frequency signal during the gate time period is seldom an integer, and thus the method is likely to cause an error at the beginning and the end of the gate time period—underestimating or overestimating by a half cycle, for example.

In view of this, to measure time, it is usually necessary to maximize the gate time period in order to handle as many cycles as possible and thereby reduce errors. However, the aforesaid solution is performed at the cost of a great increase in the testing time and with the tendency to decrease resolution due to a short gate time period arising from a short period of time measurement and a small number of instances of time measurement.

### SUMMARY

It is an objective of the present invention to increase the computation speed and accuracy of measurement in the course of time measurement.

Another objective of the present invention is to reduce circuit-occupied area and reduce power consumption.

In order to achieve the above and other objectives, the present invention provides a method for measuring time, comprising the steps of: providing a reference signal; generating a plurality of phase shift signals of a same frequency based on the reference signal, the phase shift signals being spaced apart from each other by a fixed phase; setting a clock mask, the clock mask starting from a start signal for commencement of time measurement and ending at an end signal for termination of time measurement; counting a number Nd1 of second triggering states occurring to the phase shift signals during a time period from a point in time of commencement of the clock mask to occurrence of a first triggering state to the reference signal; counting a number Nb of cycles of the reference signal based on the first triggering state during a time period of the clock mask; counting a number Nd2 of the second triggering states occurring to the phase shift signals during a time period from a point in time of termination of the clock mask to occurrence of the first triggering state to the reference signal; and obtaining a measured time t by the equation below: t=(Nb/Fb)+[Nd1/(Fb/M)]−[Nd2/(Fb/M)] wherein frequency of the reference signal is denoted by Fb and number of the phase shift signals by M, and M≧2.

In order to achieve the above and other objectives, the present invention provides a system for measuring time, comprising: a signal input end for receiving a start signal for commencement of time measurement and an end signal for termination of time measurement; a timer connected to the signal input end for receiving the start signal and the end signal, generating a reference signal of a frequency Fb, generating M phase shift signals based on the reference signal, characterized by a same frequency, and spaced apart from each other by a fixed phase, generating a clock mask starting from the start signal and ending at the end signal, counting a number Nd1 of second triggering states occurring to the phase shift signals during a time period from a point in time of commencement of the clock mask to occurrence of a first triggering state to the reference signal, counting a number Nb of cycles of the reference signal during the time period of the clock mask based on the first triggering state, counting a number Nd2 of second triggering states occurring to the phase shift signals during a time period from a point in time of termination of the clock mask to occurrence of a first triggering state to the reference signal, and outputting values Fb, M, Nb, Nd1, and Nd2; and a computing device connected to the timer for receiving the values and performing computation with the equation below to obtain a measured time t, t=(Nb/Fb)+[Nd1/(Fb/M)]−[Nd2/(Fb/M)] wherein M≧2.

In an embodiment, the timer comprises: a fundamental frequency generating unit for generating a fundamental frequency signal; a frequency multiplying unit connected to the fundamental frequency generating unit for turning the fundamental frequency signal into the reference signal by frequency multiplication; and a programmable gate array connected to the signal input end for receiving the start signal and the end signal, connected to the frequency multiplying unit for receiving the reference signal, and adapted to generate the values M, Nb, Nd1, and Nd2 and output the values Fb, M, Nb, Nd1, and Nd2.

In an embodiment, the computing device is one of a control unit and a computer device.

In an embodiment, the first triggering state is one of a rising edge triggering state and a falling edge triggering state, and the second triggering state is one of a rising edge triggering state and a falling edge triggering state.

In an embodiment, four or eight said phase shift signals are generated.

In an embodiment, frequency Fb of the reference signal is directly replaced with a default value.

Accordingly, a method and system for measuring time of the present invention eliminate time measurement errors by quick and precise multiphase processing and multiply the accuracy of measurement in accordance with the quantity of generated phase shift signals, so as to reduce the area occupied by a circuit and reduce power consumption.

### BRIEF DESCRIPTION OF THE DRAWINGS

Objectives, features, and advantages of the present invention are hereunder illustrated with specific embodiments in conjunction with the accompanying drawings, in which:

FIG. 1 is a timing diagram of a method for measuring time according to an embodiment of the present invention;

FIG. 2 is a flow chart of the method for measuring time according to an embodiment of the present invention; and

FIG. 3 is a function block diagram of a system for measuring time according to an embodiment of the present invention.

### DETAILED DESCRIPTION

The steps of a method for measuring time of the present invention are described in specific embodiments thereof and are, unless otherwise specified, interchangeable in terms of sequence. Furthermore, the concept of “connection” used in the description of specific embodiments of a system for measuring time according to the present invention is not limited to direct connection; instead, connection can also be effectuated by an intervening element. Also, a “first triggering state” and a “second triggering state” used in the description of the method and system for measuring time of the present invention comprise one of a rising edge triggering state and a falling edge triggering state. The first triggering state and the second triggering state are not mutually exclusive; hence, both the first triggering state and the second triggering state may be rising edge triggering states or falling edge triggering states.

In an embodiment of the present invention, in the course of time measurement, time is measured based on the start signal triggered by commencement of time measurement and the end signal triggered by termination of time measurement, so as to obtain accurate measured time by multiphase processing, and by predetermined equations.

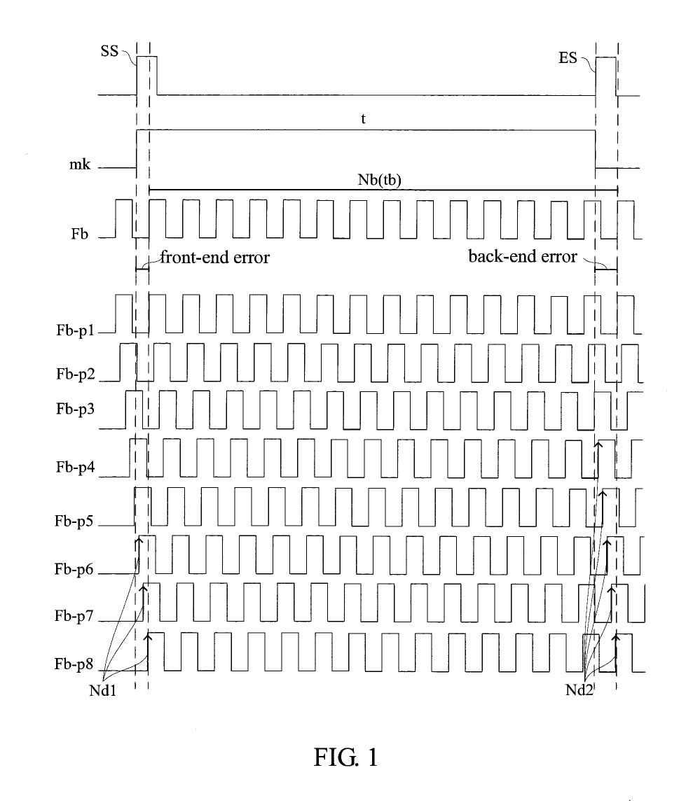

Referring to FIG. 1, there is shown a timing diagram of a method for measuring time according to an embodiment of the present invention. As shown in FIG. 1, this embodiment is exemplified by eight phase shift signals. Persons skilled in the art should be able to understand that, given at least two phase shift signals, the method and system for measuring time of the present invention is effective in eliminating errors of time measurement and thereby enhancing the accuracy of the time measured.

A method for measuring time according to an embodiment of the present invention comprises the steps of:

As shown in FIG. 1, in the course of time measurement, triggering signals, that is, a start signal SS and an end signal ES, are synchronously generated as a result of the setting of commencement of measurement and the setting of termination of measurement, respectively. In an embodiment of the present invention, a session of time measurement is preceded or accompanied by the step of providing a reference signal Fb and the step of generating multilevel phase shift signals Fb-p1˜Fb-p8 of the same frequency based on the reference signal, wherein the phase shift signals Fb-p1˜Fb-p8 are spaced apart from each other by a fixed phase.

The reference signal Fb functions as a fundamental frequency. The phase shift signals are generated from the reference signal Fb. Normally, the phase shift of a signal is effectuated by a digital clock manager (DCM) of a programmable gate array (FPGA). In this embodiment, eight phase shift signals Fb-p1˜Fb-p8 are processed by two digital clock managers, and the reference signal Fb is decomposed by a digital clock manager to form four phase shift signals. However, persons skilled in the art should be able to understand that a user can still selectively shut down four of the phase shift decomposition processes even with just one digital clock manager. Hence, with only one digital clock manager, it is still possible to decompose the reference signal Fb into two or three phase shift signals. Hence, users can select the quantity of required phase shift signals as needed and as appropriate for operation of a digital clock manager. Regarding the spacing of phase shift signals, a digital clock manager divides 360° into equal phase portions and distributes the equal phase portions among the phase shift signals. For example, the phase equals 360°/(M−1), where M denotes the number of phase shift signals.

Afterward, a clock mask mk is set. The clock mask mk thus set starts from the start signal SS for commencement of time measurement and ends at the end signal ES for termination of time measurement. Hence, the clock mask mk can be triggered synchronously with the start signal SS and the end signal ES. FIG. 1 is exemplified by the rising edge triggering signal SS and signal ES. Persons skilled in the art understand that the signal SS and the signal ES can be replaced by falling edge triggering states for denoting the point in time of commencement and the point in time of termination of the time measuring sessions, respectively.

Upon initialization of the clock mask mk, time measurement kicks off. Referring to FIG. 1, the reference signal Fb does not synchronize with the clock mask mk; hence, the time actually taken to effect the number Nb of cycles of the reference signal Fb measured does not fall within the range of the clock mask mk, thereby resulting in front-end errors and back-end errors.

Hence, in an embodiment of the present invention, the front-end and back-end errors which occur in the course of time measurement are eliminated by means of the phase shift signals. The front-end errors and back-end errors are described below based on signal timing.

Regarding the front-end errors, the number Nd1 of second triggering states (rising-edge or falling-edge triggering states) that occur to the phase shift signals Fb-p1˜Fb-p8 during the time period from the point in time of commencement of the clock mask mk to the point in time when a first triggering state occurs to the reference signal Fb is counted.

Regarding the back-end errors, the number Nd2 of second triggering states (rising-edge or falling-edge triggering states) that occur to the phase shift signals Fb-p1˜Fb-p8 during the time period from the point in time of termination of the clock mask mk to the point in time when a first triggering state occurs to the reference signal Fb is counted.

Counting the second triggering states that occur to the phase shift signals Fb-p1˜Fb-p8 means that a back-end error time period requires selecting the rising edge triggering state as the second triggering state when a front-end error time period requires selecting the rising edge triggering state as the second triggering state, or means that a back-end error time period requires selecting the falling edge triggering state as the second triggering state when a front-end error time period requires selecting the falling edge triggering state as the second triggering state. As shown in FIG. 1, the rising edge triggering state is selected to be the second triggering state, thereby setting Nd1 to 3 and Nd2 to 5.

As shown in FIG. 1, the time actually taken to go through a time measurement session is denoted by t as expressed by equation (1):

t=tb+td1−td2 (1)

Hence, in a subsequent calculation process, the number Nd1 and the number Nd2 are used in calculating front-end error time td1 and back-end error time td2 to therefore eliminate front-end and back-end errors.

Nb denotes the number of cycles of the reference signal Fb measured based on the first triggering state within the time period of the clock mask mk Fb denotes the frequency of the reference signal Fb. M denotes the number of the phase shift signals. The feature “being based on the first triggering state” means that the counting of the number of cycles of the reference signal Fb is in line with the point in time of termination of the front-end error time period td1. Hence, as shown in FIG. 1, the point in time of commencement of the counting of the number of cycles of the reference signal Fb starts from the rising edge triggering state rather than the falling edge triggering state. Conversely, if the time period td1 is changed to a time period starting from the point in time of commencement of the clock mask mk and ending at the point in time of occurrence of a falling edge triggering state (first triggering state) to the reference signal Fb, the front-end error time period td1 will end at the falling edge triggering state, and the point in time of commencement of the counting of the number of cycles of the reference signal Fb will start from the falling edge triggering state.

Hence, as indicated by the relationship between time, frequency, and number of cycles, clock mask time tb can be calculated by equation (2),

tb=(Nb/Fb) (2)

the front-end error time td1 is calculated by equation (3),

td1=[Nd1/(Fb/M)] (3)

the back-end error time td2 is calculated by equation (4),

td2=[Nd2/(Fb/M)] (4)

Accordingly, given equation (1), the measured time t is calculated by equation (5),

t=(Nb/Fb)+[Nd1/(Fb/M)]−[Nd2/(Fb/M)] (5)

wherein M denotes the number of the phase shift signals, with M≧2, indicating that at least two said phase shift signals are generated.

Furthermore, as indicated by equation (5), the more the phase shift signals are, the more the multiplication of enhancement of accuracy of measurement is. Hence, when compared with a conventional method which is not based on calibration of front-end errors and back-end errors, the method shown in FIG. 1 and disclosed in an embodiment of the present invention increases accuracy eightfold. The more the phase shift signals are, the shorter the time period is, thereby eliminating increasingly small errors.

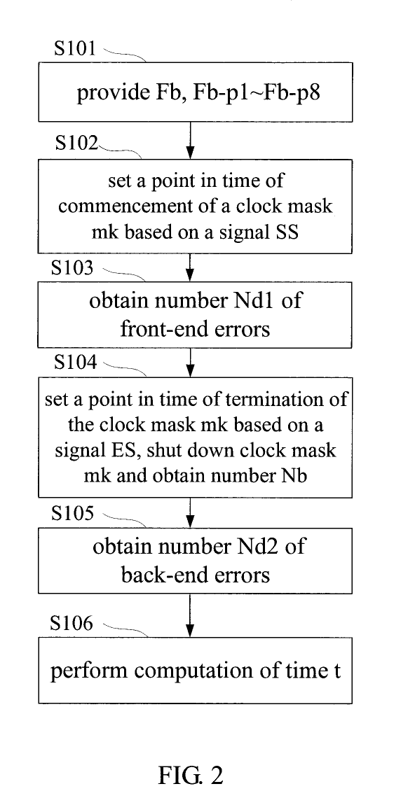

Referring to FIG. 2, there is shown a flow chart of the method for measuring time according to an embodiment of the present invention. Referring to FIG. 1, commencement of time measurement depends on the start signal SS, except for provision of the reference signal Fb and the phase shift signals Fb-p1˜Fb-p8 thereof in advance (or in synchrony with the clock mask). The method for measuring time based on signal timing comprises the steps of: providing the reference signal Fb, and a plurality of phase shift signals Fb-p1˜Fb-p8 (S101); setting the point in time of commencement of the clock mask mk based on the start signal SS (S102); obtaining the number Nd1 of front-end errors (S103); shutting down the clock mask mk and obtaining the number Nb based on the point in time of termination of the clock mask, wherein the point in time of termination of the clock mask is set by the end signal ES (S104); obtaining the number Nd2 of back-end errors (S105); and performing computation by equation (5) to obtain the measured time t (S106).

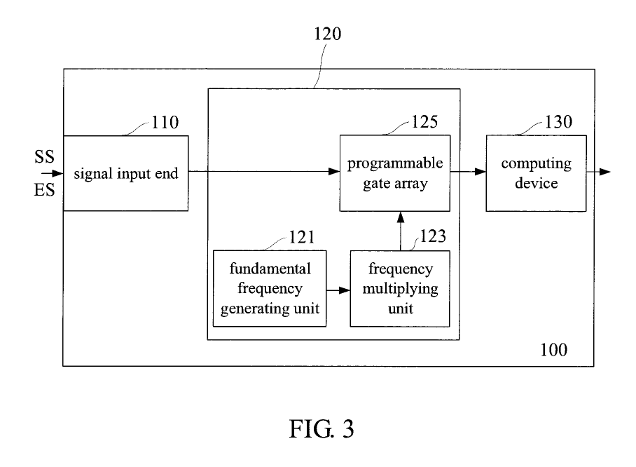

Referring to FIG. 3, there is shown a function block diagram of a system for measuring time according to an embodiment of the present invention. As shown in FIG. 3, a system 100 for measuring time comprises a signal input end 110, a timer 120, and a computing device 130.

The signal input end 110 receives the start signal SS for commencement of time measurement and the end signal ES for termination of time measurement.

The timer 120 is connected to the signal input end 110 for receiving the start signal SS and the end signal ES. The timer 120 generates the following signals and/or values: the reference signal Fb, the M phase shift signals which are spaced apart from each other by a fixed phase, the clock mask mk that starts from the start signal SS and ends at the end signal ES, the number Nd1 of the second triggering states occurring to the phase shift signals during the front-end error time period, the number Nb of the first triggering states occurring to the reference signal Fb during the time period of the clock mask mk, the number Nd2 of the second triggering states occurring to the phase shift signals during the back-end error time period, and the outputted value Fb, M, Nb, Nd1, and Nd2.

In an embodiment, the timer 120 comprises a fundamental frequency generating unit 121, a frequency multiplying unit 123, and a programmable gate array 125. The fundamental frequency generating unit 121 generates a fundamental frequency signal. Normally, a low fundamental frequency is generated by a crystal oscillator to cut costs, and then the fundamental frequency is boosted by the frequency multiplying unit 123 connected to the fundamental frequency generating unit 121 for functioning as the reference signal Fb.

The programmable gate array 125 comprises a digital clock manager for functioning as a phase shift generating circuit, a differential circuit for performing upper or lower differentiation (rising edge triggering or falling edge triggering) to count Nd1 and Nd2, and a mask circuit for generating the clock mask mk and counting the reference signal Fb. Accordingly, the programmable gate array 125 generates the values M, Nb, Nd1, and Nd2 and outputs the count values Fb, M, Nb, Nd1, and Nd2.

The programmable gate array 125 is a conventional element. The system for measuring time according to an embodiment of the present invention achieves the objectives of the present invention by means of logical elements of the system for measuring time. The method for measuring time according to an embodiment of the present invention reduces the required number of the logical elements, dispenses with a large-sized programmable gate array chip, and thus reduces the circuit-occupied area and downsizes the product. For example, if the computing function of a computing device is also incorporated into the programmable gate array, the required number of the logical elements will be greatly increased, thereby increasing the circuit-occupied area. Due to its structural design, the programmable gate array has to effectuate the computation operation by a logical means at the cost of increasing the requirement of high-speed logical elements. Although a special high-priced programmable gate array having a computing structure circuit therein can perform high-speed computation and require the space requirement of logical elements, it incurs an excessively high cost.

The computing device 130 is connected to the timer 120 for receiving the values and performing computation with equation (5) to obtain the measured time t. The computing device 130 is a control unit (MCU) or a computer device. If the computing device 130 is a control unit, then the control unit is usually disposed on the same circuit board as the timer 120 is, such that the time measuring system 100 in its entirety is integrated onto a module; however, the computing device 130 can also be an external computer device for processing a computation procedure in whole with data provided by a measuring module.

To reduce errors further, it is feasible to perform a high-precision measurement process on the generated reference signal Fb beforehand. To preclude any error which might otherwise be produced because a frequency actually generated by a fundamental frequency generating unit and a frequency multiplier is different from a given frequency level (that is, a frequency level set forth in the specifications of the fundamental frequency generating unit and the frequency multiplier), it is feasible to measure the reference signal Fb in advance by means of a high-precision frequency counter having a higher resolution than the frequency of the reference signal Fb, and then use the measured reference signal Fb as a default value to be directly stored in the computing device 130. In doing so, in every instance of measurement, the default value always applies to the frequency of the reference signal Fb, thereby dispensing with the need to use a parameter set forth in the specifications of the fundamental frequency generating unit and the frequency multiplier.

In conclusion, a method and system for measuring time of the present invention eliminate time measurement errors by quick and precise multiphase processing and multiply the accuracy of measurement in accordance with the quantity of generated phase shift signals. An embodiment of the present invention achieves eightfold reduction (corresponding to eight phase shift signals) in errors, effectuates high-precision measurement of time, and reduces the area occupied by a circuit.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A method for measuring time, comprising the steps of:
providing a reference signal;
generating a plurality of phase shift signals of a same frequency based on the reference signal, the phase shift signals being spaced apart from each other by a fixed phase;
setting a clock mask, the clock mask starting from a start signal for commencement of time measurement and ending at an end signal for termination of time measurement;
counting a number Nd1 of second triggering states occurring to the phase shift signals during a time period from a point in time of commencement of the clock mask to occurrence of a first triggering state to the reference signal;
counting a number Nb of cycles of the reference signal based on the first triggering state during a time period of the clock mask;
counting a number Nd2 of the second triggering states occurring to the phase shift signals during a time period from a point in time of termination of the clock mask to occurrence of the first triggering state to the reference signal; and
obtaining a measured time t by the equation below:
t=(Nb/Fb)+[Nd1/(Fb/M)]−[Nd2/(Fb/M)]
wherein frequency of the reference signal is denoted by Fb and number of the phase shift signals by M, and M≧2.

2. The method of claim 1, wherein the first triggering state is one of a rising edge triggering state and a falling edge triggering state.

3. The method of claim 1, wherein the second triggering state is one of a rising edge triggering state and a falling edge triggering state.

4. The method of claim 1, wherein four or eight said phase shift signals are generated.

5. The method of claim 1, further comprising replacing frequency Fb of the reference signal with a default value.

6. The method of claim 1, wherein the fixed phase equals 360°/(M−1).

7. A system for measuring time, comprising:
a signal input end for receiving a start signal for commencement of time measurement and an end signal for termination of time measurement;
a timer connected to the signal input end for receiving the start signal and the end signal, generating a reference signal of a frequency Fb, generating M phase shift signals based on the reference signal, characterized by a same frequency, and spaced apart from each other by a fixed phase, generating a clock mask starting from the start signal and ending at the end signal, counting a number Nd1 of second triggering states occurring to the phase shift signals during a time period from a point in time of commencement of the clock mask to occurrence of a first triggering state to the reference signal, counting a number Nb of cycles of the reference signal during the time period of the clock mask based on the first triggering state, counting a number Nd2 of second triggering states occurring to the phase shift signals during a time period from a point in time of termination of the clock mask to occurrence of a first triggering state to the reference signal, and outputting values Fb, M, Nb, Nd1, and Nd2; and
a computing device connected to the timer for receiving the values and performing computation with the equation below to obtain a measured time t,
t=(Nb/Fb)+[Nd1/(Fb/M)]−[Nd2/(Fb/M)]
wherein M≧2.

8. The system of claim 7, wherein the timer comprises:
a fundamental frequency generating unit for generating a fundamental frequency signal;
a frequency multiplying unit connected to the fundamental frequency generating unit for turning the fundamental frequency signal into the reference signal by frequency multiplication; and
a programmable gate array connected to the signal input end for receiving the start signal and the end signal, connected to the frequency multiplying unit for receiving the reference signal, and adapted to generate the values M, Nb, Nd1, and Nd2 and output the values Fb, M, Nb, Nd1, and Nd2.

9. The system of claim 8, wherein the computing device replaces the value Fb with a default value.

10. The system of claim 7, wherein the computing device is one of a control unit and a computer device.

11. The system of claim 7, wherein the first triggering state is one of a rising edge triggering state and a falling edge triggering state, and the second triggering state is one of a rising edge triggering state and a falling edge triggering state.
